(19) United States
(12) Patent Application Publication
(10) Pub. No.: US 2026/0033443 A1
(43) Pub. Date: Feb. 5, 2026

(54) Photometric Crop Surveillance System Coupled with Directional, Variable-Flow Ground Sprayer with Wind Compensation for Targeted Disease Treatment and Variable-Rate Water/Fertilizer/Herbicide Application

(71) Applicant: Vincent Loccisano, Wellesley, MA (US)

(72) Inventor: Vincent Loccisano, Wellesley, MA (US)

(21) Appl. No.: 19/358,028

(22) Filed: Oct. 14, 2025

(51) Int. Cl. A01G 25/16; A01C 23/04; A01M 7/00; B64U 20/80; B64U 101/40; G06V 20/10; G06V 20/17

(52) U.S. Cl. CPC A01G 25/16; A01C 23/047; A01M 7/0089; B64U 20/80; G06V 20/17; G06V 20/188; B64U 2101/40; G06V 2201/07

(57) ABSTRACT

A system and method combines photometric crop surveillance with a ground-mounted directional, variable-flow sprayer that compensates for wind to enable selective, per-patch application of water, fertilizer, or crop-protection products. Photometric imagery is processed to produce georeferenced treatment targets and recommended application quantities. Wind-field estimations and local wind-sensing are used to compute aim offsets, droplet size, and flow/dwell and shielding parameters that compensate for advection and turbulence. The system commands a sprayer with aimable nozzles and proportional flow control with per-target, wind-compensated parameters to selectively treat sub-areas at different doses, while minimizing drift. Follow-up photometric verification and logged wind telemetry enable closed-loop learning of drift/advection models.

### TECHNICAL FIELD

This disclosure relates to agricultural monitoring and precision application of water, fertilizer, herbicides and similar substances. More particularly, it concerns systems and methods that use photometric surveillance (e.g., multispectral/red-edge/NIR imaging) to detect crop stress, disease, nutrient deficiency, or weed infestations, and to command a ground-mounted, directional, variable-flow sprayer that compensates for wind to selectively apply water, fertilizer, or herbicide at different rates to distinct sub-areas within the sprayer's operating zone.

### BACKGROUND

In agricultural crop-spraying, conventional spot-application systems suffer from off-target drift and inconsistent deposition when wind is present. When spraying, wind direction must be carefully monitored to avoid water bodies, residential zones and neighboring crops. Application must be selective, requiring compensation for local wind conditions to maintain accuracy and reduce environmental impacts.

Photoelectric sensors are high-powered sensors that emit light beams to detect targets with a certain reflectivity or quantity of interrupted light. They are of various types. A reflective-type photoelectric sensor detects light beams that are reflected by a target. A thru beam sensor measures a change in light quantity caused by the target crossing an optical axis. Photoelectric sensors enable long-range detection.

Photometric imaging can detect fine-scale spatial variation in crop conditions. These images are used to guide the application of various agricultural sprays across agricultural plots. For these sprays to be effective, there is a need for systems that detect localized need with photometric sensing, and drive precise, wind-aware directional ground application to agricultural plots.

Closed-loop verification is a process that continually quality-checks any system by observation and automatic adjustment. A closed-loop verification may use an automatic feedback loop in which the output of a system is used to confirm or correct the initial input.

An orthomosaic is a large, high-resolution, and geographically accurate map created by stitching together hundreds or even thousands of individual aerial photographs. Unlike a single, standard aerial photo, an orthomosaic is digitally corrected to remove distortions caused by camera tilt, terrain relief, and perspective. Orthomosaics enable precise measurements of distance, area, and volume.

Wind modeling is the use of computer simulations to predict the movement and destination of spray droplets after they exit the sprayer nozzle. It minimizes spray drift, keeping pesticides, herbicides, or fertilizers focused on the target crop.

Wind sensing may take forms of turbine anemometry, LiDAR wind profiling, or high-resolution forecast/gridded wind products. Anemometers on wind turbines near crops can calculate an average wind speed and direction about every 5-10 minutes, and then adjust yaw and blade furling to best capture the wind. They may use LiDAR, cup anemometers and/or ultrasonic anemometers.

Target parameterization in agricultural spraying is the process of digitally defining and quantifying the physical characteristics of a crop to create a detailed 3D model of them. This enables precise spraying. The process teaches a machine to understand the exact size, shape, and density of crops it is treating. Traditional spraying might treat a crop row as a uniform, two-dimensional wall. The sprayer applies a constant quantity of chemical along the entire row, regardless of whether the row contains tall, dense plants, small, young plants, or empty space. This is inefficient and wasteful. Target parameterization changes this by creating a precise digital representation of the actual canopy structure. This 3D “digital twin” of the crop becomes the new target for the sprayer.

Specialized sensors (LiDAR, ultrasonic, or computer-vision) capture data about a crop to create the digital representations. These sensors measure aspects like canopy height and width, canopy volume and density; total leaf area relative to ground area, and gaps.

A georeferenced map is a digital map of, for example, a farm or agricultural parcel that is linked to real-world geographic coordinates. A georeferenced image might be an aerial photograph with geographic data, such as latitude and longitude, assigned to it to create a data source that can be used in precision farming.

Safety-gating is a decision-making process that uses collected data to determine whether conditions are safe to begin or continue spraying a crop. It acts as a final safety checkpoint—a “gate” that must be open before the sprayer can operate. Its purpose is to prevent spray drift.

A drag model is a mathematical simulation used to predict the trajectory of a spray droplet by calculating the effect of air resistance on it.

An advection model is a computer simulation that calculates and predicts the movement of a substance or quantity as it is transported by the bulk motion of a fluid, like air or water.

Kriging, also known as Gaussian-process regression, is a method of interpolation, based on Gaussian process, governed by prior covariances. Kriging predicts the value of a function at a given point by computing a weighted average of the known values of the function in the neighborhood of the point. Like regression analysis, it derives a best linear unbiased estimator based on assumptions on covariances using the Gauss-Markov theorem to prove independence of the estimate and error.

Kriging is for estimating a single realization of a random field, while regression models use multiple observations of a multivariate data set.

### SUMMARY

A system and method that uses drones to capture images of an agricultural parcel and generates photometric data from these images to define treatment targets that address issues like crop stress, disease, nutrient deficiency, and the presence of weeds; and implements application quantities, accounting for wind measurements and wind estimates. For each treatment target, the system and method feeds collected data to directional sprayers on the ground. Using the input data, these sprayers treat target agricultural parcels, varying the direction, flow, and amount of spray. The sprayers have wind monitors to account for varying wind conditions in order to adjust spraying.

The system's wind model is built on data from multiple sources, beginning with high-frequency local measurements from on-board sprayer anemometers capable of detecting real-time gusts. This immediate data is augmented by a network of distributed field sensors and nearby meteorological stations to provide broader spatial context. Where available, the system can also integrate advanced remote sensing inputs, including LiDAR wind profiles and high-resolution forecast products.

This dataset is then fed into a wind field estimation engine, which combines the measured vectors with spatial interpolation techniques, accounting for terrain and canopy effects to compute a detailed wind vector field across the entire parcel. The model also calculates critical gust statistics—such as mean speed, standard deviation, and maximum gust—and estimates vertical wind-shear and near-surface turbulence, providing a comprehensive and predictive understanding of air movement for the immediate treatment window.

For each identified treatment target, the system performs a detailed wind-aware parameterization to ensure a precise and safe application. It begins by determining the exact subset of the target within the sprayer's physical reach and interpolates the specific wind vector for that location and expected execution time. A critical next step is to calculate a drift-risk score, a comprehensive metric based on wind speed, turbulence, droplet size, and the proximity of sensitive buffer zones.

Based on this risk assessment, the system computes a suite of application adjustments. This includes calculating the precise aim offset needed to counteract wind advection, modulating flow rate and dwell time to compensate for anticipated drift loss, and selecting an optimal droplet size-using coarser droplets in high winds and finer ones only in calm conditions. If the drift risk score exceeds a predefined threshold, the system recommends advanced mitigation strategies, such as deploying physical shielding like shrouds or air curtains. In extreme conditions, it will even suggest deferring the application until the weather is more favorable, ensuring both efficiency and environmental safety.

In addition, the system and method:

Estimates vertical shear and near-surface turbulence where sensor density or models permit.

Acquires photometric sensor data (RGB, multispectral, NIR/red-edge, thermal) and produces georeferenced anomaly maps;

Forms polygonal treatment targets with per-target recommended application amounts and modalities;

Computes wind-aware application plans that adjust aim, timing, flow, droplet characteristics, and shielding parameters to compensate for ambient and gust-wind conditions; and

Commands a ground-mounted directional sprayer unit with aimable nozzles and variable flow to selectively apply liquids to targets with wind compensation.

The steps of the proposed method serve to limit spray-drift and improve on-target deposition under varying wind conditions. These subroutines account for per-patch variable dosing, and employ closed-loop verifications. The checks comprise a system that enables more efficient use of water, fertilizer, and/or insecticides.

The system's execution strategy begins with dynamic, real-time compensation for wind. Central to this is aim compensation, where a ballistic model calculates the expected horizontal drift of droplets based on wind speed and fall time. The system then automatically adjusts the nozzle's aim upwind by this calculated vector, ensuring the spray plume lands precisely on its intended target. This is complemented by sophisticated flow and droplet management. The application volume is proactively increased to offset the expected drift fraction, and the system intelligently selects coarser droplet sizes at lower pressures during windy conditions to minimize off-target movement. In intermittent gusts, it can even employ pulsed dosing, applying short, high-flow bursts only during lulls in the wind.

For conditions where simple compensation is insufficient, the system employs proactive mitigation and scheduling. It can engage mechanical shielding, such as deploying physical shrouds or air curtains around the nozzle to physically contain the spray plume and reduce its susceptibility to wind. Beyond physical controls, the system incorporates intelligent timing, preferring to schedule applications during historically calm periods like early mornings, as identified by sensor data and near-term forecasts. If a treatment is urgent and conditions are unfavorable, the system can recommend alternative modalities, such as manual spot treatment with a shielded wand.

Overarching all execution strategies is a rigorous safety and regulatory gating protocol. The system will automatically block any application predicted to cause off-target deposition in sensitive buffer zones—such as waterways or neighboring properties—that exceeds allowable tolerances. It also enforces conservative wind-speed thresholds for specific chemistries as dictated by product labels. To ensure full accountability, instantaneous wind metrics are logged at the time of application, providing a verifiable record for auditing and compliance purposes.

To enable precise, real-time control, the sprayer unit is equipped with a suite of integrated hardware. A high-frequency anemometer, collocated with the nozzle turret, provides instantaneous local wind measurements right at the point of application. This is complemented by flow meters, pressure sensors, and high-precision GPS/RTK for monitoring the spray output, with optional short-range LiDAR or optical sensors to detect any displacement of the spray plume in real time.

These sensors feed into a dynamic, closed-loop feedback system that constantly compares the actual delivered spray against the precomputed model. If the measured wind causes the spray to diverge from its intended path, the system instantly adapts its aim and flow rate to correct the trajectory mid-application. For safety, this loop includes an abort function that will automatically stop the spray and stow the nozzle if a sudden gust exceeds predefined thresholds.

To ensure continuous improvement, the system incorporates a verification and adaptive learning module. This module ingests a comprehensive set of data for each application event, including pre- and post-treatment imagery, along with the detailed logs of wind conditions and execution telemetry from the sprayer. By analyzing this information, the system computes the actual deposition efficacy as a function of the specific wind conditions and the parameters used. This allows it to constantly refine its core drift models and improve its estimates for the expected drift fraction in future tasks.

Finally, all of the above data is stored as labeled tuples, creating a dataset for the supervised retraining of the system's advection and dosage models, making each subsequent application more accurate than the last.

The system's control logic is driven by a series of core calculations to ensure wind-compensated accuracy. First, it approximates droplet fall time based on a droplet's terminal velocity and the vertical distance to the target. Based on this fall time, it then calculates the horizontal advection—the distance the droplet will be pushed sideways by the wind. This advection value is then used to compute the necessary aim azimuth offset, which tells the nozzle precisely how far upwind to aim to ensure the spray lands on target. In parallel, the system calculates the required flow compensation, increasing the total volume of liquid to be sprayed to account for the portion that will be lost to the estimated drift fraction. Finally, all these factors, along with buffer distances and turbulence, are synthesized into a normalized drift-risk score, which is used as a final safety gate to approve or defer the application.

The system's operational parameters are built around high-frequency wind sensing, with a sampling rate of at least 1 Hz to reliably detect gusts within a short time window. This data informs a strict automatic no-spray threshold, typically set around 4.0 m/s, with even lower limits for more sensitive chemistries. When operating below this threshold, a conservative aim offset margin of 10-20% is added to the ballistic calculations to account for turbulence and potential model errors. The system also adjusts the droplet diameter based on conditions, selecting coarser droplets (150-400 μm) in windy weather and finer ones (100-250 μm) when it is calm. Ultimately, every action is governed by a drift-acceptance tolerance, ensuring that any predicted off-target deposition at sensitive buffers remains below a strict regulatory or user-defined limit.

The operational workflow begins when a UAV (drone) surveys the agricultural parcel and identifies treatment targets using photometric imaging. For each target, the system queries recent wind sensor data and short-term forecasts to compute a local wind field and a corresponding drift-risk score. If this score is within acceptable thresholds and all regulatory checks pass, the system proceeds with automated application. It calculates the necessary wind-compensated parameters—including aim offset, flow rate, and droplet size—and transmits the command to the sprayer unit for execution under closed-loop, real-time wind monitoring.

Conversely, if the risk score is too high, the system automatically defers the task, recommending either rescheduling for a calmer window, repositioning the sprayer to a more advantageous location, or escalating to manual crew action with a shielded applicator. Regardless of the outcome, all wind and execution telemetry is logged. This data, combined with verification outcomes, is then used to continuously update the system's drift models and improve its predictive accuracy for future operations.

### BRIEF DESCRIPTION OF DRAWINGS

FIG. 1 is a system diagram.

FIG. 2 is an example orthomosaic with a wind-vector field overlay, and treatment polygons with wind-compensated aim offsets.

FIG. 3 is a vector diagram showing sprayer aim, beam geometry, and wind compensation.

FIG. 4 illustrates the system's decision flow.

### DETAILED DESCRIPTION

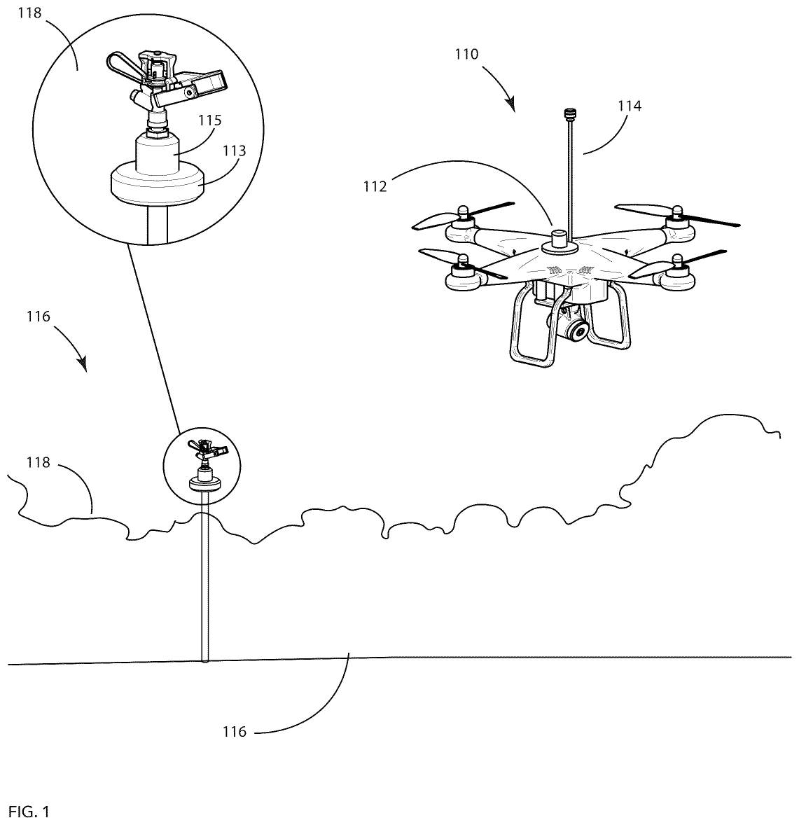

FIG. 1 shows a system diagram of the crop-management system and method. Unmanned aerial vehicles (UAVs or “drones”) 110, equipped with photometric sensors 112 and wind sensors 114, are used to survey an agricultural parcel. The wind sensors, such as ultrasonic or cup-type anemometers, are configured to measure wind speed and direction at multiple altitudes, including at the height of a ground-based sprayer unit 116 and at the crop canopy height 118. These measurements are captured at a high sampling rate (e.g., 1-10 Hz) to detect wind gusts.

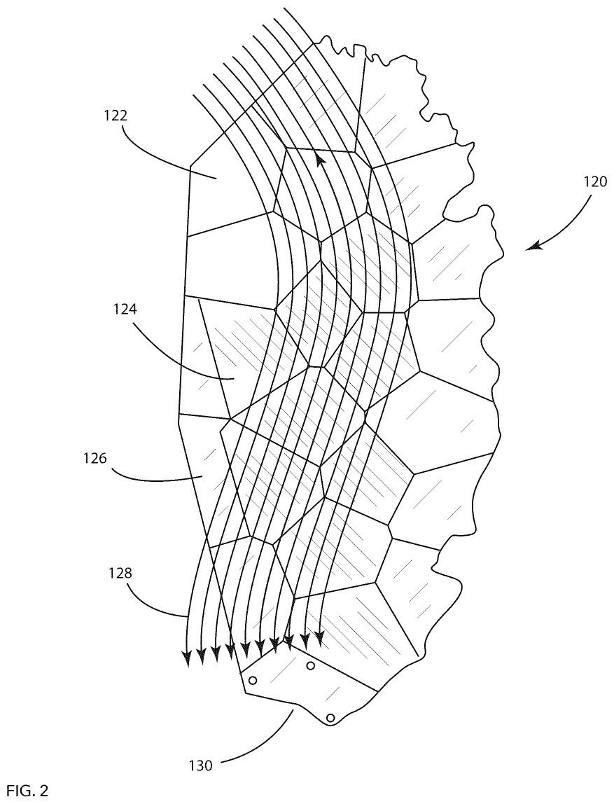

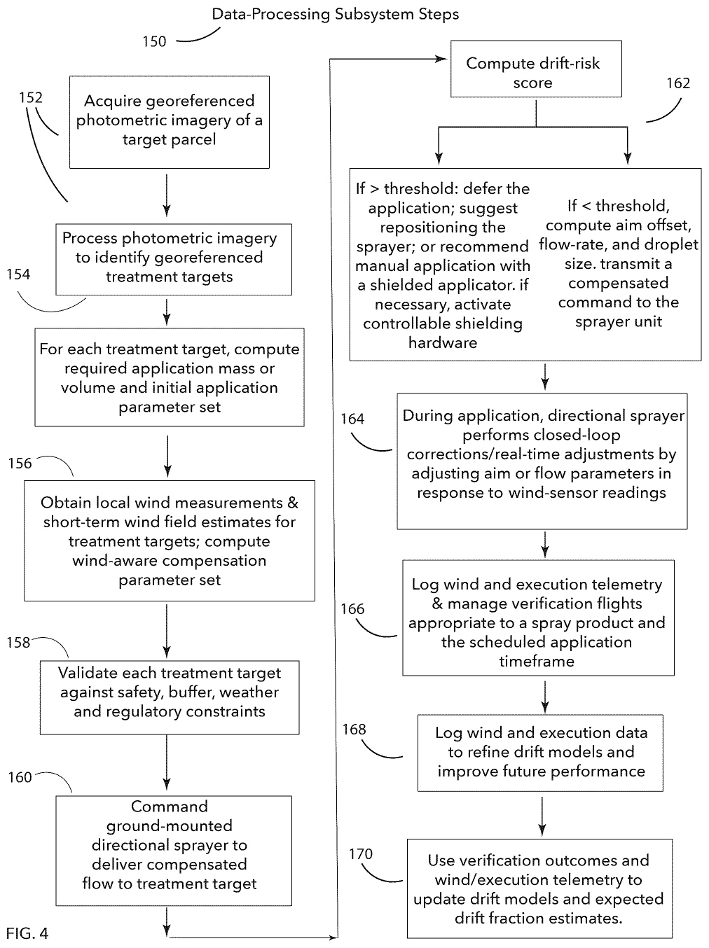

A data-processing subsystem processes the photometric imagery to generate a georeferenced map (FIG. 2) identifying one or more treatment targets. These targets may correspond to areas of localized crop stress, disease, nutrient deficiency, or weed presence. For each target, the system computes a recommended application amount of a fluid to spray. Concurrently, the subsystem processes wind measurements to compute a wind-aware compensation parameter set, which includes aim offsets and flow adjustments, as detailed in FIG. 4.

Based on this analysis, the data-processing subsystem computes a compensated nozzle-aim and flow profile for each treatment target, and transmits this information as commands to a ground-mounted directional sprayer unit 116.

The sprayer unit 116 includes an aimable nozzle assembly with a directional control module 113 capable of spraying discrete angular sectors within its operating footprint, and a variable-flow control system 115 to modulate liquid flow rates. The nozzle assembly is collocated with one or more high-frequency local wind sensors such as anemometers 114, for real-time wind measurement. In some embodiments a directional control module 113 is a servo-motor in combination with a communication module for receiving parameters and directing the sprayer unit 116 in desired directions. A variable-flow control system may include a flow-control valve and a communication module for receiving flow-control parameters to compensate for wind speed and direction. One skilled in the art understands that manual override actuators may be incorporated into the directional control module 113 and the variable-flow control system 115. In the present embodiment an impulse sprinkler is depicted. One skilled in the art understands that any sprinkler or sprayer unit that may be discretely directed may also be outfitted with a directional control module 113 and/or a variable-flow control system 115.

Upon receiving the wind-aware compensation parameter set, the sprayer unit 116 applies it to selectively deliver a liquid to each treatment target, while actively compensating for wind. This compensation includes adjusting droplet size and flow rate to reduce an estimated spray-drift fraction. The unit 116 performs closed-loop corrections by adjusting its aim and flow in real time, based on readings from local wind sensors 114. Additionally, the sprayer unit may be equipped with sensors such as flow meters, pressure sensors, GPS/RTK, and short-range LiDAR to monitor the liquid application and detect plume displacement.

FIG. 2 shows an example orthomosaic image of an agricultural plot 120, overlaid with polygonal treatment targets 122-126 and a wind-vector field 128. This composite imagery guides the precise application of agricultural sprays from sprayer units 130.

Densely shaded polygons 124 denote dense vegetation areas; lightly shaded polygons 126 denote lighter vegetation; and polygons with no shading 122 denote paved, gravel or bare-earth sections.

Each sprayer unit sprays an area defined by the system as needing water or fertilizer, with the system compensating for wind in real time. sprayer units spray at varying concentrations, pressures, and distance ranges; for example, the system directs a sprayer unit to dispense at higher pressure in certain wind conditions. The system dynamically changes spray pressures/flowrates to respond to upwind or downwind conditions.

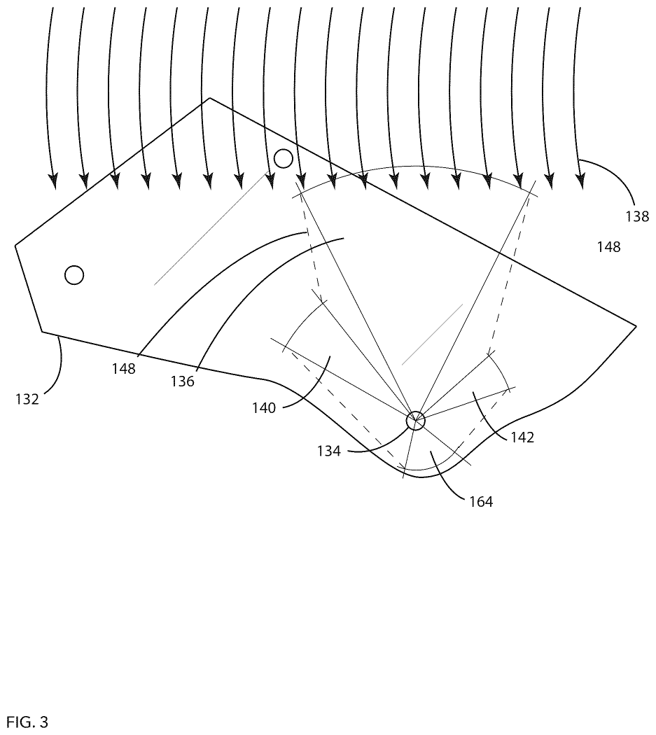

FIG. 3 illustrates how wind-compensated aim offsets are generated. A wind-aware compensation parameter set includes an aim-offset vector computed from a drag or advection model that considers wind speed, direction, and droplet-fall time. A simplified approximation for droplet-fall time can be expressed as:

$$t\_fall \approx ( 2 \times droplet\_terminal \_velocity ) \hat{} - 1 \times vertical\_distance$$

One skilled in the art understands that other drag models may also be used.

After the system and method assesses the watering needs of a polygonal segment, it directs spray distribution according to each segment's needs, which also accounts for wind direction and wind speed. A segment of a polygonal map 132 has sprayer unit heads. An example sprayer unit 134 distributes liquid:

At a relatively high pressure 136 when spraying into the wind 138

At a relatively lower pressure 140 when spraying adjacent to wind-direction

At a yet lower pressure 142 when spraying sideways to the wind 144

At a yet low pressure 146 when spraying downwind

Broken lines show transition areas 148.

FIG. 4 is a decision-flow diagram illustrating the system's process, from sensing to execution. The data-processing subsystem 150 first acquires and processes georeferenced treatment targets from photometric imagery 152.

For each treatment target, the system computes 154 required application mass or volume and initial application parameter sets. It obtains local wind measurements and short-term wind field estimates 156 for treatment targets and computes wind-aware compensation parameter sets.

The system validates 158 each treatment target against safety, buffer, weather and regulatory constraints. It then commands 160 ground-mounted directional sprayers to deliver compensated flows to treatment targets.

For each target, it computes a drift risk score 162, which is a function of wind speed, turbulence, droplet size, and distance to sensitive buffer zones. If the drift risk score is below a predefined threshold, the system computes the necessary aim offset, flow rate, and droplet size. The required flow is compensated for anticipated drift loss using the formula:

$$Vdelivered = Vrequired / ( 1 - Fdrift )$$

where Fdrift is the estimated drift fraction. The system then transmits a compensated command to the sprayer unit for execution.

If the drift risk score exceeds the threshold, the system may defer the application; suggest repositioning the sprayer; or recommend manual application with a shielded applicator. To further mitigate risk, controllable shielding hardware, such as a shroud or air curtain, may be deployed.

During application, the system performs real-time adjustments 164. For example, a sprayer may be directed to use pulsed dosing during intermittent gusts, or select coarser droplet sizes (e.g., 150-400 μm) in windy conditions to reduce drift. All wind and execution data are logged to refine the system's drift models and improve future performance. The system and method uses verification outcomes and wind/execution telemetry to update drift models and expected drift fraction estimates.

The system and method logs wind and execution telemetry data 166 and manages verification flights appropriate to a spray product and its scheduled application timeframe. It logs wind and execution data to refine drift models and improve future performance 168. Finally, it uses verification outcomes and wind/execution telemetry to update drift models and expected drift-fraction estimates 170.

1. A system for precision agricultural treatment, the system comprising:
an unmanned aerial vehicle (UAV) equipped with a photometric sensor configured to capture imagery of an agricultural parcel; and
a ground-mounted directional sprayer unit comprising an aimable nozzle, a variable-flow control system, and a local wind sensor configured to measure real-time wind conditions at the sprayer unit; and
a data-processing subsystem configured to:
generate one or more georeferenced treatment targets from the imagery captured by the UAV; and
compute for each treatment target, a wind-aware compensation parameter set based on one or more wind measurements; and
command the ground-mounted directional sprayer unit to apply a fluid to the one or more treatment targets using the wind-aware compensation parameter set, wherein the sprayer unit is further configured to perform closed-loop corrections to the application of the fluid based on the real-time wind conditions measured by its local wind sensor.

2. The system of claim 1 wherein:
The UAV is further equipped with a UAV wind sensor, and wherein the data-processing subsystem is further configured to compute the wind-aware compensation parameter set using wind measurements from both the UAV wind sensor and the local wind sensor.

3. The system of claim 1 wherein:
The wind-aware compensation parameter set includes at least one of an aim-offset vector, a flow-rate adjustment, a droplet-size adjustment, or a pulsed-dosing timing instruction.

4. The system of claim 1 wherein:
the data-processing subsystem is further configured to compute a wind vector field across the agricultural parcel by integrating wind data from a plurality of sources, the sources selected from a group consisting of the local wind sensor, a UAV wind sensor, networked field sensors, and meteorological forecast data.

5. The system of claim 1 wherein:
The data-processing subsystem is further configured to compute a drift risk score for each treatment target and to conditionally execute the command to the sprayer unit only if the drift risk score is below a predefined threshold.

6. The system of claim 1 wherein:
the data-processing subsystem is configured to compute a required volume of fluid for delivery by adjusting a prescribed volume based on an estimated drift fraction ( [symbol] ) according to the formula:

[symbol]

7. The system of claim 1 wherein:
The ground-mounted directional sprayer unit further comprises a controllable shielding hardware, and wherein the wind-aware compensation parameter set includes a command to deploy the shielding hardware.

8. The system of claim 1 wherein:
The data-processing subsystem is further configured to log execution data, including wind measurements and application parameters, and to update a spray drift model based on the logged execution data.

9. A method for precision agricultural treatment, the method comprising:
capturing, with an unmanned aerial vehicle (UAV) equipped with a photometric sensor, imagery of an agricultural parcel; and
generating, with a data-processing subsystem, one or more georeferenced treatment targets from the captured imagery; and
measuring, with a local wind sensor collocated with a ground-mounted directional sprayer unit, real-time wind conditions; and
computing, with the data-processing subsystem, a wind-aware compensation parameter set for each of the one or more treatment targets based on the measured real-time wind conditions; and
commanding the ground-mounted directional sprayer unit to apply a fluid to the one or more treatment targets using the computed wind-aware compensation parameter set; and
adjusting, in real-time by the ground-mounted directional sprayer unit, the application of the fluid based on the measured real-time wind conditions.

10. The method of claim 9 further comprising:
measuring, with a wind sensor on the UAV, wind conditions at a plurality of altitudes over the agricultural parcel, and wherein computing the wind-aware compensation parameter set is further based on the wind conditions measured at the plurality of altitudes.

11. The method of claim 9 further comprising:
computing a drift risk score for a treatment target based on the measured wind conditions; and
conditionally proceeding with commanding the sprayer unit based on the drift risk score being below a predefined threshold.

12. The method of claim 9 wherein:
Commanding the sprayer unit comprises varying a pressure of the fluid application based on a direction of spray relative to a direction of the wind, including applying a higher pressure when spraying into the wind compared to when spraying downwind.

13. The method of claim 9 further comprising:
logging execution telemetry data during the application of the fluid and updating a spray drift model using the logged execution telemetry data to improve future performance.
